(19) United States
(12) Patent Application Publication
(10) Pub. No.: US 2024/0200367 A1
(43) Pub. Date: Jun. 20, 2024

(54) VEHICLE DOOR LOCKING ASSEMBLY

(71) Applicant: NISSAN NORTH AMERICA, INC., Franklin, TN (US)

(72) Inventors: David KOVIE, Livonia, MI (US); Edward ORCSIK, LaSalle (CA); Christopher HERRALA, Milford, MI (US); James HAUPT, Livonia, MI (US)

(21) Appl. No.: 18/069,188

(22) Filed: Dec. 20, 2022

(51) Int. Cl. E05B 77/04

(52) U.S. Cl. CPC E05B 77/04

(57) ABSTRACT

A vehicle door locking assembly includes a vehicle body structure, a door movably connected to the vehicle body structure, a fastener fixed to the door, and a locking member fixed to the vehicle body structure. The door is movable between a closed position and an open position relative to the vehicle body structure. The fastener is received by an opening in the vehicle body structure when the door is in the closed position. The locking member is configured to be received by the fastener upon an impact event to the vehicle body structure such that the door is prevented from moving from the closed position to the open position.

### BACKGROUND

### Technical Field

The present disclosure generally relates to a locking assembly for a vehicle. More specifically, the present disclosure relates to a locking assembly for a vehicle that prevents a door from opening responsive to an impact event.

### Background Information

A vehicle is provided with a structure configured to receive an impact force during an impact event. A need exists for a vehicle door locking assembly that prevents a door from opening during an impact event.

### SUMMARY

In view of the state of the known technology, one aspect of the present disclosure is to provide a vehicle locking assembly including a vehicle body structure, a door movably connected to the vehicle body structure, a fastener fixed to the door, and a locking member fixed to the vehicle body structure. The door is movable between a closed position and an open position relative to the vehicle body structure. The fastener is received by an opening in the vehicle body structure when the door is in the closed position. The locking member is configured to be received by the fastener upon an impact event to the vehicle body structure such that the door is prevented from moving from the closed position to the open position.

Another aspect of the present disclosure is to provide a vehicle door locking assembly including a vehicle body structure, a door movably connected to the vehicle body structure, a fastener fixed to the door, a boot connected to the vehicle body structure, and a locking member fixed to the vehicle body structure. The door is movable between a closed position and an open position relative to the vehicle body structure. The boot is configured to receive the fastener when the door is in the closed position. The locking member is configured to pass through the boot and to be received by the fastener upon an impact event to the vehicle body structure such that the door is prevented from moving from the closed position to the open position. The fastener and the boot are made of different materials.

Also other objects, features, aspects and advantages of the vehicle door locking assembly will become apparent to those skilled in the art from the following detailed description, which, taken in conjunction with the annexed drawings, discloses exemplary embodiments of the vehicle door locking assembly.

### BRIEF DESCRIPTION OF THE DRAWINGS

Referring now to the attached drawings which form a part of this original disclosure:

FIG. 1 is a rear elevational view of a vehicle equipped with a vehicle door locking assembly in accordance with an exemplary embodiment in which a rear door is in a closed position;

FIG. 2 is a rear elevational of the vehicle of FIG. 1 in which the rear door is in an open position;

FIG. 3 is an elevational view in cross section of the vehicle door locking assembly of FIG. 1 in which the rear door is in the closed position;

FIG. 4 is a perspective view of the vehicle door locking assembly of FIG. 3 in which the rear door is in the closed position;

FIG. 5 is a perspective view of a fastener removed from a boot of the vehicle door locking assembly of FIG. 2 when the door is in the open position;

FIG. 6 is a perspective view of a fastener received by the boot of the vehicle door locking assembly of FIG. 5 when the door is in the closed position;

FIG. 7 is an elevational view in cross section of the vehicle door locking assembly of FIG. 2 in which the door is in the open position;

FIG. 8 is an elevational view in cross section of the vehicle door locking assembly with the rear door in the closed position after an impact event to a vehicle body structure in which a locking member is received by the fastener; and

FIG. 9 is a front elevational view of a fastener of a vehicle door locking assembly in accordance with another exemplary embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

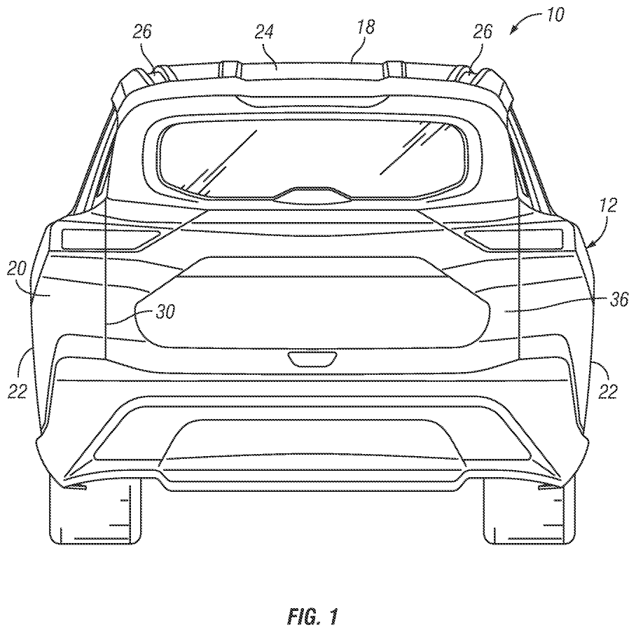

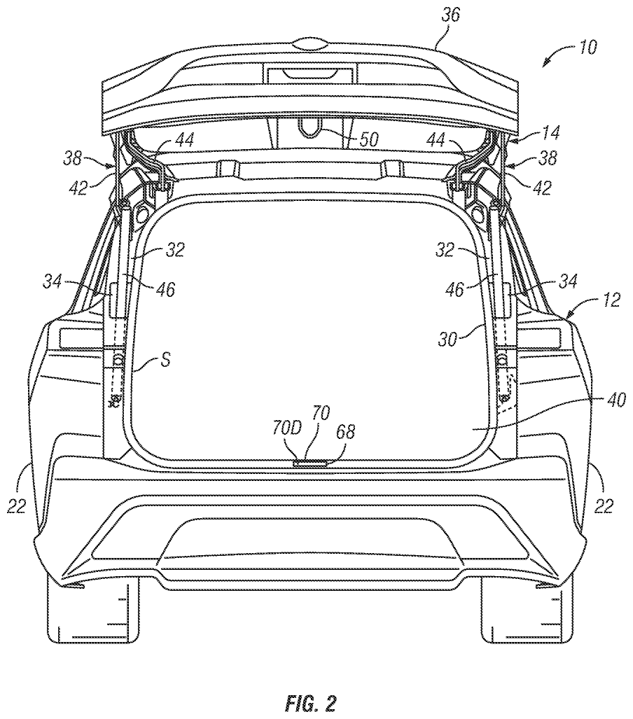

Referring initially to FIGS. 1 and 2, a vehicle 10 having a vehicle body structure 12 including a rear door assembly 14 is illustrated in accordance with an exemplary embodiment.

The vehicle body structure 12 includes a roof structure 18 (also referred to as the roof 18), a rear end area 20 and a side walls 22. The rear end area 20 defines a rear door opening 30, gutter areas, or gutters, 32, and cavity openings 34. The rear end area 20 includes a thick flexible sealing member S that is installed thereto such that the flexible sealing member S surrounds the rear door opening 30.

The roof structure 18 includes a main panel 24 with roof ditches 26 defined at either lateral side thereof. The main panel 24 is attached to respective upper ends of the side walls 22 along the roof ditch 26 in a conventional manner. The roof ditches 26 are recessed areas or troughs that extend from the front of the roof structure 18 to the rear end area 20 at each side of the main panel 24.

The rear end area 20 can be a separate panel fixed to the panels that define the side walls 22 and the main panel 24 of the roof structure 18. Alternatively, the rear end area 20 can be formed as part of a rear end area of each of the side walls 22 and the main panel 24 of the roof structure 18. The rear end area 20 defines the rear door opening 30 and the gutter areas 32.

The gutter areas 32 extend along opposite sides of the rear door opening 30 and at least partially surround the rear door opening 30. The gutter areas 32 are shaped and contoured to divert water and debris away from the rear door opening 30. Each of the gutter areas 32 further defines a cavity opening 34.

The rear door assembly 14 includes a rear door 36 and a four-bar linkage 38, as shown in FIG. 2. The rear door 36 is movable between a closed position, as shown in FIG. 1, and an open position, as shown in FIG. 2, relative to the vehicle body structure 12. The rear door 36 is movable between the closed position, or a door closed orientation, covering the rear door opening 30 and the gutters 32, as shown in FIG. 1, and the open position, or a door open orientation, exposing the rear door opening 30 and the gutters 32, as shown in FIG. 2.

As shown in FIG. 1, the rear door 36 in the closed position covers and at least partially conceals a cargo area at the rear of the vehicle body structure 12. As shown in FIG. 2, moving the rear door 36 to the open position exposes and allows access to the cargo area 40 at the rear of the vehicle body structure 12.

The four-bar linkage assembly 38 supports the rear door 36 for movement between the closed position and the open position, as shown in FIGS. 1 and 2. The four-bar linkage assembly 38 includes a pair of rearward members 42, a pair of forward members 44 and a pair of extenders 46. With the rear door 36 in the open position, as shown in FIG. 1, the rearward members 42 and the forward members 44 support the rear door 36 at a location such that at least a portion of the rear door 36 is disposed above the roof structure 18. With the rear door 36 in the closed position, as shown in FIG. 2, the rearward members 42 and the forward members 46 are located within the gutters 32 and are concealed by the rear door 36.

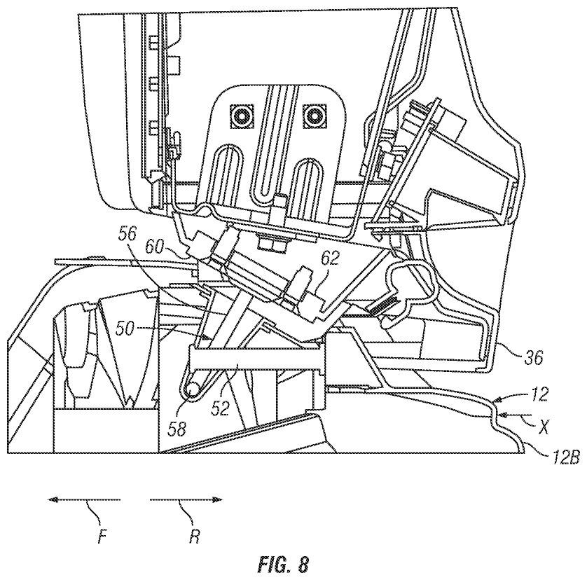

A locking assembly 48 for the vehicle 10 includes a fastener 50 and a locking member 52, as shown in FIGS. 1, 3, 4, 7 and 8. The locking member 52 is configured to be moved from a first position, as shown in 3, to a second position, as shown in FIG. 8, responsive to an impact even to the vehicle body structure 12. When the locking member 52 is in the first position, the locking member 52 does not interfere with the fastener 50 such that the rear door 36 is movable between the closed and open positions. When the locking member 52 is moved to the second position responsive to an impact event, the locking member 52 is received by the fastener 50 such that the rear door 36 is prevented from moving from the closed position to the open position.

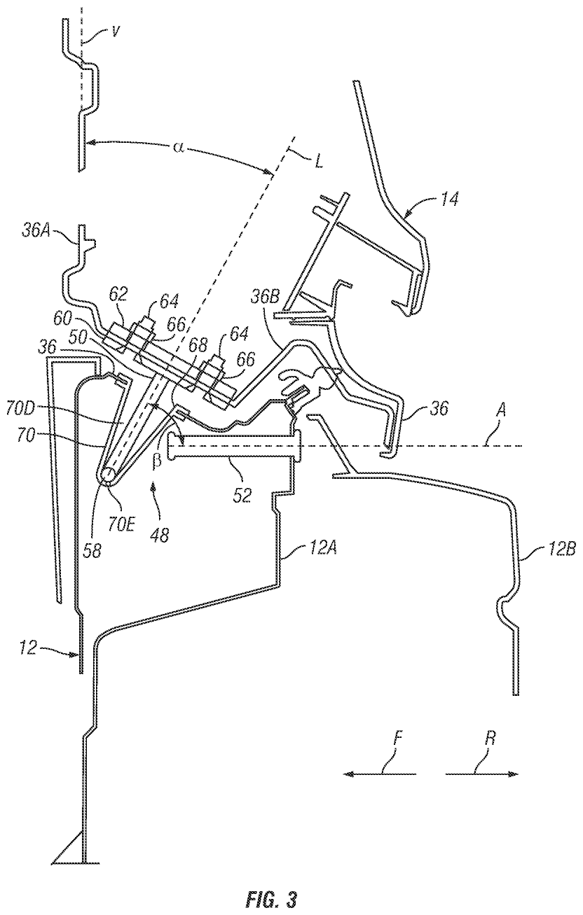

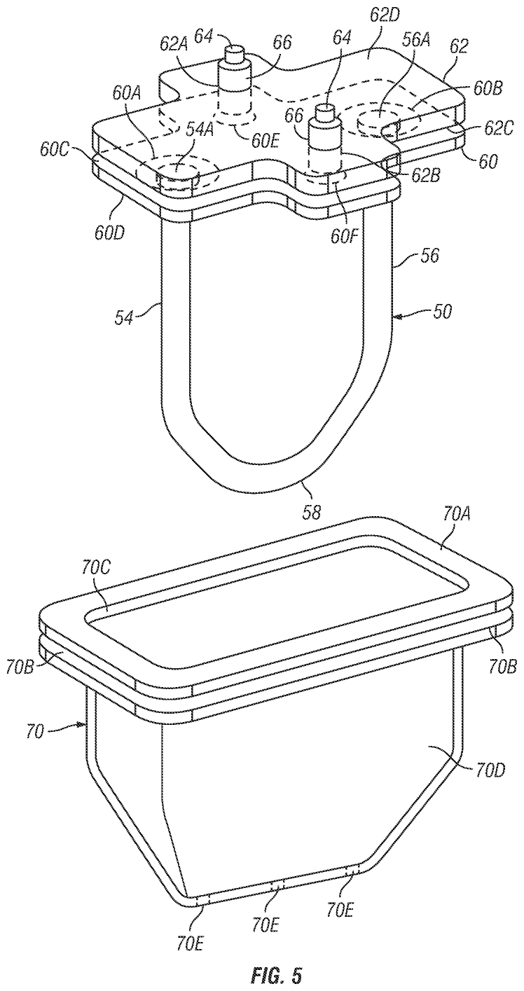

The fastener 50 is fixed to the rear door 36, as shown in FIGS. 2 and 3. As shown in FIG. 5, the fastener 50 is a substantially U-shaped member, although the fastener 50 can have any shape configured to engage the locking member 52 responsive to an impact event to prevent movement of the rear door 36 from the closed position to the open position. The substantially U-shaped fastener 50 has a first leg 54 and a second leg 56 connected by a curved portion 58. The first leg 54 is substantially parallel to the second leg 56. The fastener 50 is preferably made of a metallic material, although any suitable material can be used.

The fastener 50 is connected to an outer plate 60, as shown in FIG. 5. The outer plate 60 preferably has first and second openings 60A and 60B that extend from an inner surface 60C to an outer surface 60D of the outer plate 60. The openings 60A and 60B on the inner surface 60C of the outer plate 60 are preferably countersunk. The outer plate 60 has third and fourth fastener openings 60E and 60F, as shown in FIG. 3. The outer plate is preferably made of a metallic material.

First and second ends 54A and 56A of the first and second legs 54 and 56, respectively, are received by the first and second openings 60A and 60B in the outer plate 60. The first and second ends 54A and 56A of the fastener 50 are swaged in the countersunk openings on the inner surface 60C of the outer plate 60 to securely retain the fastener 50 to the outer plate 60. The first and second legs 54 and 56 can be welded to the inner surface 60C of the outer plate 60 to further secure the fastener 50 to the outer plate 60.

An inner plate 62 has first and second openings 62A and 62B that extend from an outer surface 62C to an inner surface 62D of the inner plate 62, as shown in FIG. 3. The inner plate 62 is preferably made of a metallic material.

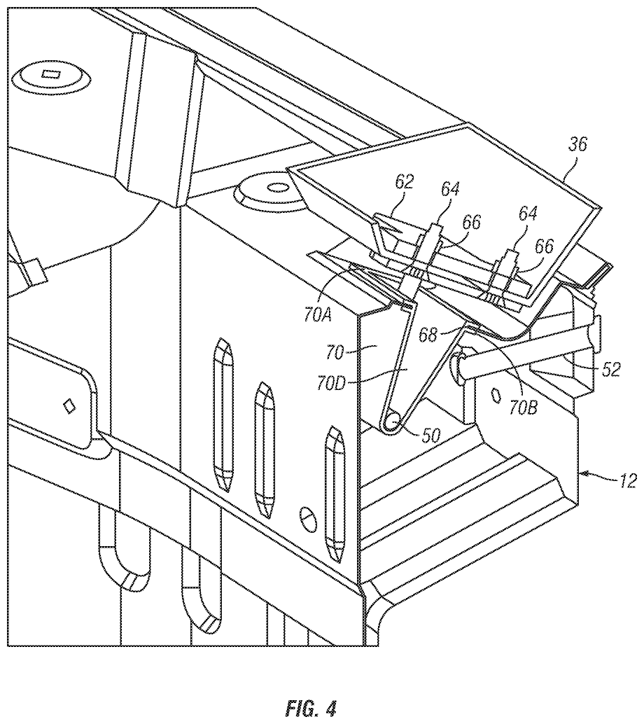

The inner plate 62 is connected to the outer plate 60 such that the rear door 36 is disposed between the outer plate 60 and inner plate 62, as shown in FIGS. 3 and 4. The fastener 50 is preferably connected to the outer plate 60 before the outer plate 60 is connected to the inner plate 62. The inner surface 60C of the outer plate 60 is disposed adjacent an outer surface 36A of the rear door 36. The outer surface 62C of the inner plate 62 is disposed adjacent an inner surface 36B of the rear door 36. The third opening 60E in the outer plate 60 is aligned with the first opening 62A in the inner plate 62. The fourth opening 60F in the outer plate 60 is aligned with the second opening 62B in the inner plate 62. A fastener 64 is inserted through each pair of aligned openings to secure the fastener 50 to the door 36. The fastener 64 is preferably inserted through the outer plate 60, the rear door 36, and the inner plate 62. A nut 66 is disposed on each fastener 64 and is tightened against the inner surface 62D of the inner plate 62.

The locking member 52 is fixed to the vehicle body structure 12, as shown in FIGS. 2, 3, 4, 7 and 8. The locking member 52 is configured to be received by the fastener 50 upon an impact event to the vehicle body structure 12, as shown in FIG. 8, such that the rear door 36 is prevented from moving from the closed position (FIG. 1) to the open position (FIG. 2).

The locking member 52 is fixed to the vehicle body structure 12 in any suitable manner, such as by a threaded connection or by welding. The locking member 52 is made of any suitable material, such as metal. The locking member 52 can be a metallic bolt fixed to the vehicle body structure 12, such as to a support member or bumper 12A, as shown in FIGS. 3, 7 and 8.

An opening 68 is disposed in the vehicle body structure 12, as shown in FIG. 2. The opening 68 is configured to receive the fastener 50 when the rear door 36 is in the closed position, as shown in FIG. 3.

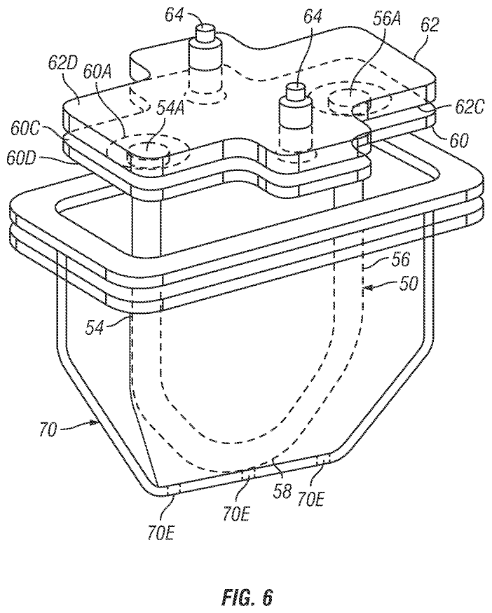

A boot 70 is connected to the vehicle body structure 12, as shown in FIGS. 2-8. The boot 70 is disposed in the opening 68 in the vehicle body structure 12. The boot 70 includes an outer flange 70A and an inner flange 70B. The inner flange 70B is spaced from the outer flange 70A such that the vehicle structure can be received therebetween, as shown in FIGS. 3, 4, 7 and 8. An opening 70C in the boot 70 provides access to a cavity 70D of the boot 70. The boot 70 is made of any suitable material, such as a rubber material, such as ethylene propylene diene monomer (EPDM) rubber, or a plastic material, such as polyoxymethylene thermoplastic. Preferably, the boot is made of a material having sound dampening properties.

The boot 70 is configured to receive the fastener 52 when the door 36 is in the closed position, as shown in FIGS. 1, 3 and 4. The boot 70 is preferably made of a material having sound dampening properties or the boot 70 includes a sound dampening feature, such as a rib, that absorbs movement of the fastener 52 while the vehicle 10 is traveling, such that unintentional noises generated by movement of the fastener 50 in the boot 70 are substantially prevented or muffled. At least one drain hole 70E can be disposed in the boot 70 to allow water collecting in the cavity 70D to drain out of the boot 70. The fastener 50 and the boot 70 are preferably made of different materials.

As shown in FIGS. 3, 4, 7 and 8, the fastener 50 is connected to the door 36. The boot 70 is disposed in the opening 68 in the vehicle body structure 12, such as a structural beam or bumper 12A extending in a lateral direction of the vehicle 10. The vehicle body structure 12 is configured to be received between the outer flange 70A and the inner flange 70B. The locking member 52 is rigidly fixed to the vehicle body structure 12, such as a bumper fascia 12B.

A longitudinal axis A of the locking member 52 is disposed above a lowermost portion of the boot 70, as shown in FIG. 3. The longitudinal axis A of the locking member 52 is disposed above the curved portion 58 of the fastener 50 when the door 36 is in the closed position. An angle α between a vertical line V and a longitudinal axis of the boot 70 is approximately thirty degrees. The vertical line V is perpendicular to the ground. An angle R between the longitudinal axis L of the fastener 50 and the longitudinal axis A of the locking member 52 is less than ninety degrees when the door 36 is in the closed position, as shown in FIG. 3. The locking member 52 is disposed in a rearward direction R of the vehicle 10 relative to the boot 70, as shown in FIG. 3. The locking member 52 is disposed rearward of the fastener 50 when the door 36 is in the closed position.

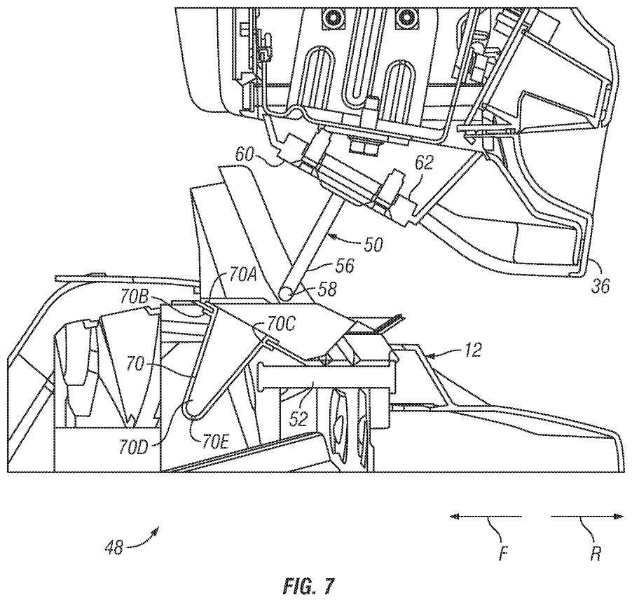

The fastener 50 is configured to be movably received by the boot 70 disposed in the opening 68 in the vehicle body structure 12 when the door 36 is in the closed position. As shown in FIGS. 3, 4 and 6, when the door 36 is in the closed position, the fastener 50 is received by the boot 70. As shown in FIGS. 5 and 7, when the door 36 is moved to the open position, the fastener 50 is removed from the boot 70.

During an impact event, a force is received by the vehicle body structure 12, such as the force X received by the bumper fascia 12B, as shown in FIG. 8. The force X received by the vehicle body structure 12 causes the locking member 52 to move in the vehicle forward direction F. In other words, the locking member 52 is configured to move in the forward direction F of the vehicle 10 responsive to the impact event. The locking member 52 is configured to pass through the boot 70 and between the first leg 54 and the second leg 56 of the fastener 50 responsive to the impact event. The locking member 52 is disposed between the first and second legs 54 and 56 of the fastener 50 such that the curved portion 58 of the fastener 50 engages the locking member 50 to substantially prevent the door from moving to the open position. In other words, movement of the door 36 from the closed position to the open position responsive to an impact event is substantially prevented by the curved portion 58 of the fastener 50 engaging the locking member 52. The locking member 52 does not engage the fastener 50 when the locking member 52 is in the first position (FIG. 3). In the first position, the locking member 52 is disposed rearward of the fastener 52 when the door 36 is in the closed position, as shown in FIG. 3. The locking member 52 does not interfere with movement of the door 36 between the closed and open positions when the locking member 52 is in the first position. When the locking member 52 is moved to a second position, as shown in FIG. 8, responsive to an impact event, the curved portion 58 of the fastener 50 engages the locking member 52 to substantially prevent movement of the door 36 from the closed position to the open position. An impact event moves the locking member 52 in the forward direction F from the first position to the second position such that the locking member 52 is received by the fastener 50 to prevent the door 36 from moving from the closed position to the open position.

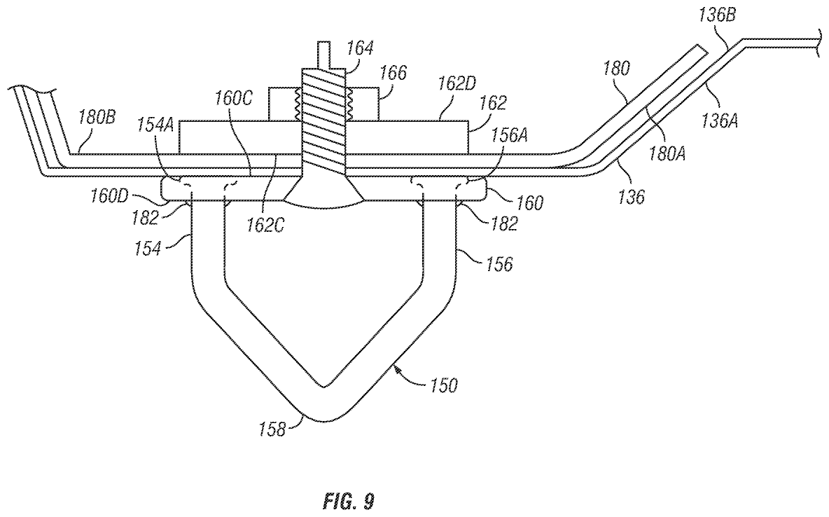

As shown in FIG. 9, a vehicle door locking assembly in accordance with another illustrated exemplary embodiment is substantially similar to the vehicle door locking assembly of the exemplary embodiment illustrated in FIGS. 1-8 except for the differences described below. Similar parts are identified with similar reference numerals, except increased by 100 (i.e., 1xx, accordingly).

A fastener 150 is connected to an outer plate 160, as shown in FIG. 9. The fastener 150 includes a first leg 154 and a second leg 156 connected by a curved portion 158. Ends 154A and 156A of the first and second legs 154 and 156 of the fastener 150 are received by openings in the outer plate 160. The ends 154A and 156A of the first and second legs 154 and 156 of the fastener 150 are preferably swaged to the inner surface 160C of the outer plate 160. A weld area 182 between the first and second legs 154 and 156 of the fastener 150 and the outer surface 160D of the outer plate 160 can be used to further secure the fastener 150 to the door 136.

The inner surface 160C of the outer plate 160 is disposed adjacent an outer surface 136A of the door 136. An outer surface 180A of a reinforcement plate, or panel, 180 is disposed adjacent an inner surface 136B of the door 136. An outer surface 162C of an inner plate 162 is disposed adjacent an inner surface 180B of the reinforcement plate 180. A fastener 164 is inserted through the outer plate 160, the door 136, the reinforcement plate 180, and the inner plate 162 to secure the fastener 150 to the door 136. A nut 166 is received by the fastener 150 and is tightened to abut the inner surface 162D of the inner plate 162.

The reinforcement plate 180 can be made of any suitable material, such as sheet metal. The reinforcement plate 180 is disposed in the mounting area of the fastener 150 to distribute a load imparted to the fastener 150 to substantially prevent removal of the fastener 150 from the door 136 due to the imparted load. A thickness of the reinforcement plate 180 is preferably larger than a thickness of the door 136.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle door locking assembly. Accordingly, these terms, as utilized to describe the present invention should be interpreted relative to a vehicle equipped with the vehicle door locking assembly.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle door locking assembly comprising:
a vehicle body structure;
a door movably connected to the vehicle body structure, the door being movable between a closed position and an open position relative to the vehicle body structure;
a fastener fixed to the door, the fastener being received by an opening in the vehicle body structure when the door is in the closed position; and
a locking member fixed to the vehicle body structure, the locking member being configured to be received by the fastener upon an impact event to the vehicle body structure such that the door is prevented from moving from the closed position to the open position.

2. The vehicle door locking assembly according to claim 1, wherein
the fastener is a substantially U-shaped member.

3. The vehicle door locking assembly according to claim 2, wherein
the fastener includes a first leg and a second leg connected by a curved portion, the locking member being configured to pass between the first leg and a second leg responsive to the impact event.

4. The vehicle door locking assembly according to claim 3, wherein
the curved portion is configured to engage the locking member to prevent movement of the door from the closed position to the open position.

5. The vehicle door locking assembly according to claim 1, wherein
the locking member is a metallic bolt.

6. The vehicle door locking assembly according to claim 1, wherein
a boot is disposed in the opening in the vehicle body structure, the boot being configured to receive the fastener when the door is in the closed position.

7. The vehicle door locking assembly according to claim 6, wherein
the boot is made of a rubber material.

8. The vehicle door locking assembly according to claim 6, wherein
the locking member is configured to pass through the boot when the locking member moves responsive to the impact event.

9. The vehicle door locking assembly according to claim 7, wherein
the fastener is made of a metallic material.

10. The vehicle door locking assembly according to claim 1, wherein
the locking member is configured to move in a forward direction of the vehicle responsive to the impact event.

11. The vehicle door locking assembly according to claim 6, wherein
an angle between a vertical line and a longitudinal axis of the boot is approximately thirty degrees.

12. The vehicle door locking assembly according to claim 6, wherein
a longitudinal axis of the locking member is disposed above a lowermost portion of the boot.

13. The vehicle door locking assembly according to claim 6, wherein
a drain hole is disposed in the boot.

14. The vehicle door locking assembly according to claim 1, wherein
an angle between a longitudinal axis of the fastener when the door is in the closed position and a longitudinal axis of the locking member is less than ninety degrees.

15. A vehicle door locking assembly comprising:
a vehicle body structure;
a door movably connected to the vehicle body structure, the door being movable between a closed position and an open position relative to the vehicle body structure;
a fastener fixed to the door;
a boot connected to the vehicle body structure, the boot being configured to receive the fastener when the door is in the closed position; and
a locking member fixed to the vehicle body structure, the locking member being configured to pass through the boot and to be received by the fastener upon an impact event to the vehicle body structure such that the door is prevented from moving from the closed position to the open position,
the fastener and the boot being made of different materials.

16. The vehicle door locking assembly according to claim 15, wherein
the fastener is a substantially U-shaped member including a first leg and a second leg connected by a curved portion, the locking member being configured to pass between the first leg and a second leg responsive to the impact event.

17. The vehicle door locking assembly according to claim 16, wherein
the curved portion is configured to engage the locking member to prevent movement of the door from the closed position to the open position.

18. The vehicle door locking assembly according to claim 15, wherein
the locking member is configured to move in a forward direction of the vehicle responsive to the impact event.

19. The vehicle door locking assembly according to claim 18, wherein
an angle between a vertical line and a longitudinal axis of the boot is approximately thirty degrees.

20. The vehicle door locking assembly according to claim 15, wherein
a longitudinal axis of the locking member is disposed above a lowermost portion of the boot.
